(19) United States
(12) Patent Application Publication
(10) Pub. No.: US 2025/0372872 A1
(43) Pub. Date: Dec. 4, 2025

(54) INTELLIGENT REFLECTING SURFACE AND METHOD FOR DRIVING THE INTELLIGENT REFLECTING SURFACE

(71) Applicant: Japan Display Inc., Tokyo (JP)

(72) Inventor: Takanori TSUNASHIMA, Tokyo (JP)

(73) Assignee: Japan Display Inc., Tokyo (JP)

(21) Appl. No.: 19/303,410

(22) Filed: Aug. 19, 2025

Related U.S. Application Data
(63) Continuation of application No. PCT/JP2024/006735, filed on Feb. 26, 2024.

(30) Foreign Application Priority Data
Mar. 24, 2023 (JP) 2023-047892

(51) Int. Cl. H01Q 3/46

(52) U.S. Cl. CPC H01Q 3/46

(57) ABSTRACT

An intelligent reflecting surface includes at least one element group including a plurality of radio-wave reflection elements arranged in a matrix shape having a first row to a mth row and a first column to a nth column. Each of the plurality of radio-wave reflection elements includes a first electrode, a liquid crystal layer over the first electrode, and a second electrode over the liquid crystal layer. In the at least one element group, the first electrode is electrically connected to an adjacent first electrode in a row direction and a column direction through a resistive element. A resistance of the resistive element is higher than a resistance of the first electrode. m and n are independently selected from natural numbers equal to or greater than 2.

### CROSS-REFERENCE TO RELATED APPLICATIONS

This application is a Continuation of International Patent Application No. PCT/JP2024/006735, filed on Feb. 26, 2024, which claims the benefit of priority to Japanese Patent Application No. 2023-047892, filed on Mar. 24, 2023, the entire contents of each are incorporated herein by reference.

### FIELD

An embodiment of the present invention relates to an intelligent reflecting surface and a driving method thereof.

### BACKGROUND

Since liquid crystal molecules have anisotropic permittivity, the permittivity of the liquid crystal layer can be controlled by adjusting the electric field applied to the liquid crystal layer containing liquid crystal molecules to control the orientation of the liquid crystal molecules. Metasurfaces utilizing such characteristics and capable of controlling reflectance characteristics of liquid crystal layers with respect to radio waves have been known (see Japanese Laid-Open Patent Publications No. H11-103201 and 2019-530387, for example).

### SUMMARY

An embodiment of the present invention is an intelligent reflecting surface. The intelligent reflecting surface includes at least one element group including a plurality of radio-wave reflection elements arranged in a matrix shape having a first row to a mth row and a first column to a nth column. Each of the plurality of radio-wave reflection elements includes a first electrode, a liquid crystal layer over the first electrode, and a second electrode over the liquid crystal layer. In the at least one element group, the first electrode is electrically connected to an adjacent first electrode adjacent in a row direction and a column direction through a resistive element. A resistance of the resistive element is higher than a resistance of the first electrode. m and n are independently selected from natural numbers equal to or greater than 2.

An embodiment of the present invention is a driving method of an intelligent reflecting surface. The intelligent reflecting surface includes at least one element group including a plurality of radio-wave reflection elements arrange in a matrix shape having a first row to a mth row and a first column to a nth column. Each of the plurality of radio-wave reflection elements includes a first electrode, a liquid crystal layer over the first electrode, and a second electrode over the liquid crystal layer. The driving method includes independently supplying a potential to the first electrodes of the radio-wave reflection element in the first row and the first column, the radio-wave reflection element in the m row and the first column, the radio-wave reflection element in the first row and the nth column, and the radio-wave reflection element in the mth row and the nth column. In the at least one element group, the first electrode is electrically connected to an adjacent first electrode in a row direction and a column direction through a resistive element. m and n are independently selected from natural numbers equal to or greater than 2.

### BRIED DESCRIPTION OF DRAWINGS

FIG. 1A is a schematic top view of an intelligent reflecting surface according to an embodiment of the present invention.

FIG. 1B is a schematic top view of an intelligent reflecting surface according to an embodiment of the present invention.

FIG. 2 is a schematic top view of a radio-wave reflection element according to an embodiment of the present invention.

FIG. 3 is a schematic cross-sectional view of a radio-wave reflection element according to an embodiment of the present invention.

FIG. 4 is a schematic cross-sectional view of a radio-wave reflection element according to an embodiment of the present invention.

FIG. 5A is a schematic cross-sectional view showing characteristics of an intelligent reflecting surface according to an embodiment of the present invention.

FIG. 5B is a schematic cross-sectional view showing characteristics of an intelligent reflecting surface according to an embodiment of the present invention.

FIG. 6 is a schematic top view explaining a driving method of an intelligent reflecting surface according to an embodiment of the present invention.

FIG. 7A is a schematic view explaining a driving method of an intelligent reflecting surface according to an embodiment of the present invention.

FIG. 7B is a schematic view explaining a driving method of an intelligent reflecting surface according to an embodiment of the present invention.

FIG. 8A is a schematic cross-sectional view explaining a driving method of an intelligent reflecting surface according to an embodiment of the present invention.

FIG. 8B is a schematic cross-sectional view explaining a driving method of an intelligent reflecting surface according to an embodiment of the present invention.

FIG. 9 is a schematic view explaining a driving method of an intelligent reflecting surface according to an embodiment of the present invention.

FIG. 10 is a schematic perspective view explaining a driving method of an intelligent reflecting surface according to an embodiment of the present invention.

FIG. 11 is a timing chart explaining a driving method of an intelligent reflecting surface according to an embodiment of the present invention.

FIG. 12 is a schematic top view of a radio-wave reflection element according to an embodiment of the present invention.

FIG. 13 is a schematic top view of a radio-wave reflection element according to an embodiment of the present invention.

### DESCRIPTION OF EMBODIMENTS

Hereinafter, each embodiment of the present invention is explained with reference to the drawings. The invention can be implemented in a variety of different modes within its concept and should not be interpreted only within the disclosure of the embodiments exemplified below.

The drawings may be illustrated so that the width, thickness, shape, and the like are illustrated more schematically compared with those of the actual modes in order to provide a clearer explanation. However, they are only an example, and do not limit the interpretation of the invention. In the specification and the drawings, the same reference number is provided to an element that is the same as that which appears in preceding drawings, and a detailed explanation may be omitted as appropriate.

In the specification and the claims, unless specifically stated, when a state is expressed where a structure is arranged “over” another structure, such an expression includes both a case where the substrate is arranged immediately above the “other structure” so as to be in contact with the “other structure” and a case where the structure is arranged over the “other structure” with an additional structure therebetween.

In the embodiments of the present invention, when a plurality of films is simultaneously fabricated in the same process, these films have the same layer structure, the same material, and the same composition. Thus, these films are defined as existing in the same layer.

### 1. Structure of Intelligent Reflecting Surface

Hereinafter, the structure of an intelligent reflecting surface according to an embodiment of the present invention is explained. This intelligent reflecting surface is a so-called liquid crystal metasurface reflector and is a device which utilizes the permittivity change resulting from the orientation change of the liquid crystal layer caused by an electric field to reflect applied radio waves in an arbitrary direction. There are no restrictions on the frequency of the radio waves which can be reflected, and the frequency is in the range of 400 MHz to 50 GHz, for example. Typically, the intelligent reflecting surface can be used to reflect radio waves in the 400 MHz to 6.0 GHz band, the 2.5 GHz to 4.7 GHz band, and the 24 GHz to 50 GHz band.

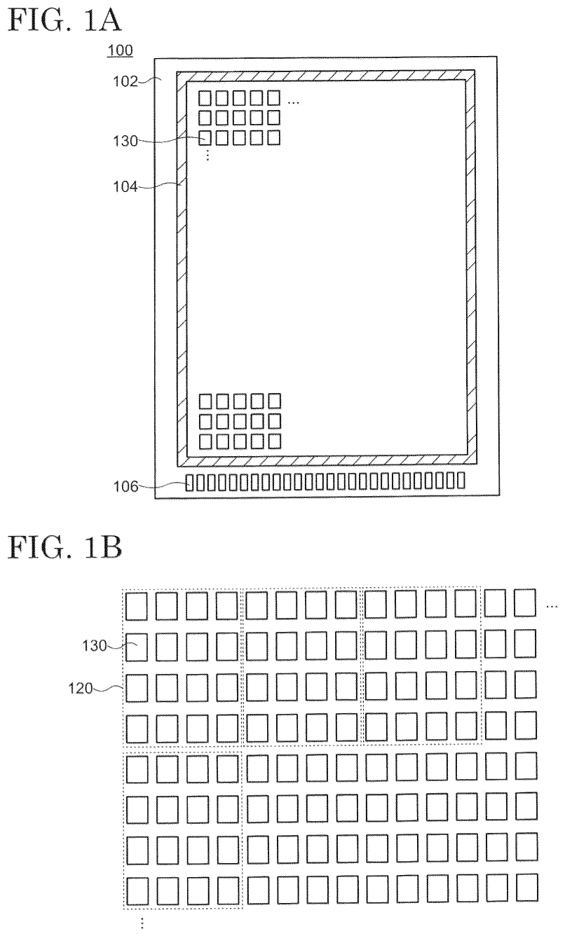

FIG. 1A shows a schematic top view of the intelligent reflecting surface 100. The intelligent reflecting surface 100 has a substrate 102 and a counter substrate which is not illustrated in FIG. 1A, and a plurality of radio-wave reflection elements 130 arranged in a matrix shape is arranged between the substrate 102 and the counter substrate. As shown in FIG. 1B which is an enlarged view of FIG. 1A, the plurality of radio-wave reflection elements 130 is divided into a plurality of element groups 120 and is driven for every plurality of element groups 120. That is, the intelligent reflecting surface 100 has at least one element group 120 including multiple radio-wave reflection elements 130. The at least one element group 120 may include a plurality of element groups 120, in which case the plurality of element groups 120 is also arranged in a matrix shape having a plurality of rows and a plurality of columns. The substrate 102 and the counter substrate are fixed to each other with a sealing material 104 including a resin such as an epoxy resin and an acrylic resin, and a liquid crystal layer described below is sealed in the space formed by the substrate 102, the counter substrate, and the sealing material 104. Terminals 106 are provided over the substrate 102 for supplying potentials (control potentials) for controlling the radio-wave reflection elements 130 from an external circuit (not illustrated).

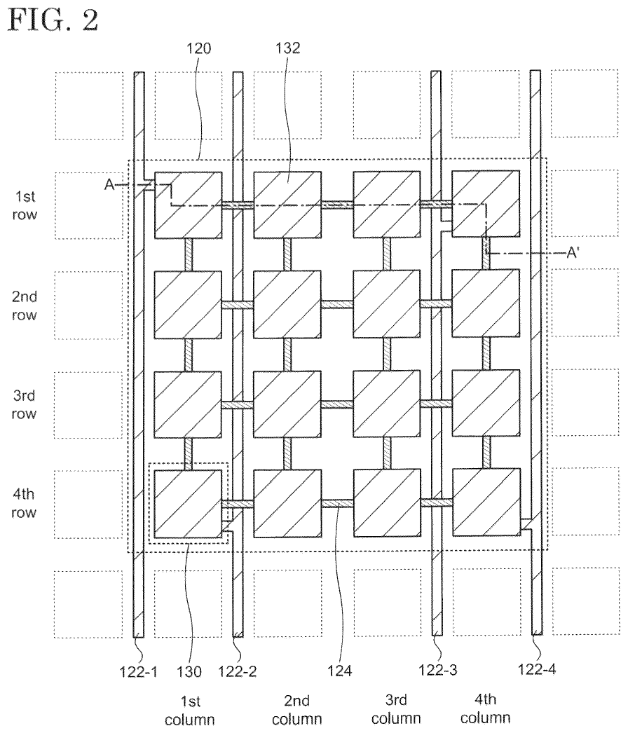

A schematic top view of the intelligent reflecting surface 100 centered on one element group 120 is shown in FIG. 2. Each element group 120 includes the plurality of radio-wave reflection elements 130 arranged in a matrix shape having a first row to a mth row and a first column to a nth column. m and n are independently selected from natural numbers equal to or greater than 2 (hereinafter, the same is applied) and both m and n are preferably equal to or greater than 4. In the example demonstrated in FIG. 2, m and n are each 4, and a total of 16 radio-wave reflection elements 130 is arranged.

Here, in each element group 120, the radio-wave reflection elements 130 adjacent in the row direction and the column direction are electrically connected through a resistive element 124. Specifically, the radio-wave reflection elements 130 located in the first row and the mth row are electrically connected to the radio-wave reflection elements 130 located in the second row and the (m−1)th row and in the same column, respectively, through the resistive elements 124. Similarly, the radio-wave reflection elements 130 in a jth row (j is a natural number greater than 1 and smaller than m. The same is applied hereafter.) are electrically connected to the radio-wave reflection elements 130 located in a (j−1)th row and in the same column and to the radio-wave reflection elements 130 located in the (j+1)th row and in the same column through the resistive elements 124, respectively. The radio-wave reflection elements 130 located in the first column and the nth column are electrically connected to the radio-wave reflection elements 130 located in the second column and the (n−1) column and in the same row, respectively. Similarly, the radio-wave reflection elements 130 in a kth column (k is a natural number greater than 1 and smaller than n. The same is applied hereafter.) are electrically connected to the radio-wave reflection elements 130 located in a (k−1) column and in the same row and to the radio-wave reflection elements 130 located in a (k+1) column and in the same row through the resistive elements 124, respectively.

In the intelligent reflecting surface 100, the control potentials are selectively supplied to a part of the plurality of intelligent reflecting surface elements 130 included in one element group 120. Specifically, the intelligent reflecting surface 100 has a plurality of wirings 122 extending in the column direction, four of which (a first wiring 122-1, a second wiring 122-2, a third wiring 122-3, and a fourth wiring 122-4) are electrically connected to one element group 120 or to the radio-wave reflection elements 130 in the first row and the first column, in the mth row and the first column, in the first row and the nth column, and in the mth column and the nth column of each of the plurality of element groups 120 arranged in the column direction. Each wiring 122 forms the terminal 106 at an edge portion of the substrate 102 (see FIG. 1) and is independently supplied with the control potential from an external circuit which is not illustrated. Thus, the control potentials can be independently supplied to the radio-wave reflection elements 130 in the first row and the first column, in the mth row and the first column, in the first row and the nth column, and in the mth row and the nth column through the wirings 122.

The above structure simplifies the structure and makes it possible to provide an intelligent reflecting surface capable of reflecting radio waves in arbitral directions at a low cost. The details of this structure are described below.

### (1) Substrate

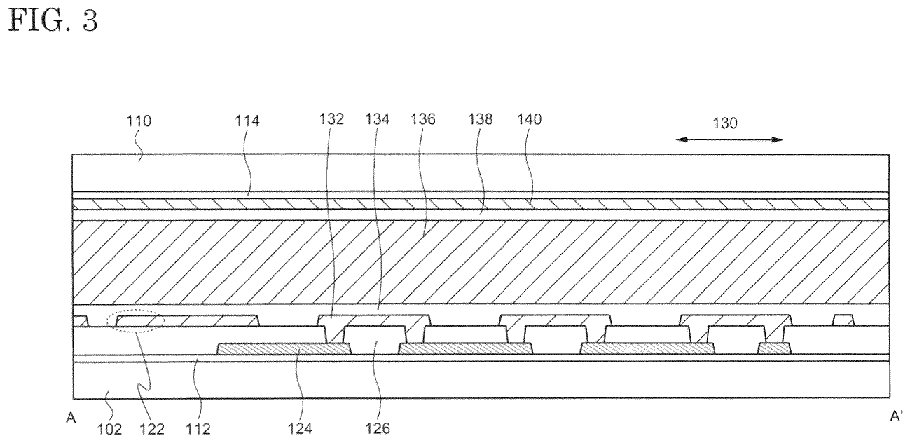

A schematic view of the cross section along the chain line A-A′ in FIG. 2 is shown in FIG. 3. Each radio-wave reflection element 130 is provided directly over the substrate 102 or over an undercoat 112 which is an optional component. The substrate 102 and the counter substrate 110 are provided to give physical strength to the intelligent reflecting surface 100 and to provide a surface for arranging the radio-wave reflection elements 130. The substrate 102 and/or the counter substrate 110 may be flexible. The substrate 102 and the counter substrate 110 may include an inorganic insulator such as glass or quartz, a semiconductor such as silicon, a polymer such as a polyimide, a polycarbonate, and a polyester, and a metal such as aluminum, copper, and stainless steel. When a conductive material such as a metal is included, it is preferable to provide a film containing an insulator such as silicon oxide and silicon nitride over the surface over which the radio-wave reflection elements 130 are provided, i.e., the surface of the substrate 102 on the counter substrate 110 side and the surface of the counter substrate 110 on the substrate 102 side. The substrate 102 and the counter substrate 110 may or may not transmit visible light.

The undercoat 112 which is an optional component may be composed of one or a plurality of films containing a silicon-containing inorganic compound such as silicon oxide and silicon nitride, for example. The undercoat 112 may be formed by a sputtering method or a chemical vapor deposition (CVD) method, or the like.

### (2) Radio-Wave Reflection Element and Resistive Element

As shown in FIG. 3, each radio-wave reflection element 130 has a first electrode (also called a patch electrode) 132, a first orientation film 134 over the first electrode 132, a liquid crystal layer 136 over the first orientation film 134, a second orientation film 138 over the liquid crystal layer 136, and a second electrode 140 over the second orientation film 138. The first electrodes 132 of adjacent radio-wave reflection elements 130 are electrically connected by the resistive element 124.

The resistive element 124 is provided over the substrate 102 directly or through the undercoat 112, and the plurality of first electrodes 132 is disposed over the resistive element 124 through a first interlayer insulating film 126. The resistive elements 124 may be spaced apart from each other or may be continuous between adjacent first electrodes 132. Although not illustrated, a single resistive element 124 with a lattice shape may be provided in one element group 120 in the latter case. The first electrode 132 is electrically connected to the resistive element 124 through an opening formed in the first interlayer insulating film 126. The resistive element 124 and the first electrode 132 may be connected directly or through a conductive film which is not illustrated.

The resistive element 124 is configured to have a higher electrical resistance than the first electrode 132. There are no restrictions on the material included in the resistive element 124, and it is preferable to use a material having a resistance equal to or greater than 100 times and equal to or smaller than 2000 times the resistance of the material included in the first electrode 132. For example, resistive element 124 may be configured to include a conductive oxide having a light-transmitting property such as indium-tin oxide (ITO) and indium-zinc oxide (IZO). Alternatively, the resistive element 124 may include silicon. In this case, the resistive element 124 may be configured to include a dopant (e.g., boron, phosphorus, arsenic, and the like) to adjust conductivity.

On the other hand, the first electrode 132 of the radio-wave reflection element 130 is configured to have lower electrical resistance than the resistive element 124 and includes, for example, a metal such as copper, aluminum, tungsten, molybdenum, and titanium and an alloy including at least one of these metals. The first electrode 132 may have a monolayer structure or may have a stacked-layer structure in which layers of different compositions are stacked. For example, a stacked structure of a layer containing a conductive oxide and a layer containing the above metal or alloy may be employed. Alternatively, the first electrode 132 including a metal or an alloy may have a mesh shape in order to provide a light-transmitting property to the intelligent reflecting surface 100.

The first interlayer insulating film 126 may be formed with one or a plurality of films containing a silicon-containing inorganic compound or a polymer such as an epoxy resin and an acrylic resin. When a silicon-containing inorganic compound is included, the first interlayer insulating film 126 may be formed with a sputtering method or a CVD method. When a polymer is included, the first interlayer insulating film 126 may be formed by applying a wet film-formation method such as a spin coating method, an inkjet method, and a printing method. The first interlayer insulating film 126 is formed to absorb the unevenness caused by the resistive element 124, by which the first electrode 132 can be provided on a flat surface.

The first orientation film 134 is disposed over the plurality of first electrodes 132. The first orientation film 134 is provided to control the orientation of the liquid crystal molecules structuring the liquid crystal layer 136 disposed thereover.

The first orientation film 134 may be provided continuously over the plurality of radio-wave reflection elements 130. In other words, the first orientation film 134 may be provided so as not to be divided between adjacent radio-wave reflection elements 130 but to be shared by all of the radio-wave reflection elements 130 in the element group 120. The first orientation film 134 may also be provided so as to be shared by adjacent element groups 120.

The first orientation film 134 includes a polymer such as a polyimide and a polyester. The first orientation film 134 is formed by utilizing a wet film-formation method such as an ink-jet method, a spin-coating method, a printing method, and a dip-coating method, and its surface is subjected to a rubbing treatment. Alternatively, the first orientation film 134 may be formed by a photo-alignment treatment.

The liquid crystal layer 136 contains liquid crystal molecules. The structure of the liquid crystal molecules is not limited. Thus, the liquid crystal molecules may be nematic liquid crystals, smectic crystals, cholesteric crystals, or chiral smectic liquid crystals. The thickness of the liquid crystal layer 136 is, for example, equal to or more than 20 μm and equal to or less than 50 μm or equal to or more than 30 μm and equal to or less than 50 μm. Thus, the height of the sealing material 104 is also selected from this range. Although not illustrated, spacers may be provided in the liquid crystal layer 136 to maintain this thickness throughout the entire intelligent reflecting surface 100. Note that, if the aforementioned thickness of the liquid crystal layer 136 is employed in a liquid crystal display device, the high responsiveness required to display moving images cannot be obtained, and it becomes significantly difficult to express the functions of a liquid crystal display device.

Similar to the first orientation film 134, the second orientation film 138 is also provided to control the orientation of the liquid crystal molecules. The second orientation film 138 may also be continuous over adjacent radio-wave reflection elements 130 and may be formed to be shared by the plurality of radio-wave reflection elements 130 in the element group 120. Furthermore, the second orientation film 138 may be provided so as to be shared by the adjacent pixel groups 120. The first orientation film 134 and the second orientation film 138 are arranged so that the direction in which the first orientation film 134 orients the liquid crystal molecules is parallel to that of the second orientation film 138. The liquid crystal molecules are oriented in a certain direction by the first orientation film 134 and the second orientation film 138.

The second electrode 140 is provided over the counter substrate 110 (under the counter substrate 110 in FIG. 3). As an optional component, the second electrode 140 may be formed over the substrate 102 through an overcoat 114 including one or a plurality of films containing a silicon-containing inorganic compound. As shown in FIG. 3, the second electrode 140 may be provided as a single integrated electrode provided over the plurality of radio-wave reflection elements 130. That is, the second electrode 140 may be provided to be shared by the plurality of radio-wave reflection elements 130. The second electrode 140 may also be formed as a single electrode shared by the plurality of element groups 120. The second electrode 140 is supplied with a constant potential from an external circuit through a wiring which is not illustrated.

Similar to the first electrode 132, the second electrode 140 may include, for example, a metal such as copper, aluminum, tungsten, molybdenum, and titanium, an alloy containing at least one of these metals, or a conductive oxide such as ITO or IZO. The second electrode 140 may also have a monolayer structure or a stacked-layer structure in which layers of different compositions are stacked. The second electrode 140 may also be formed by applying a sputtering method, a CVD method, or the like.

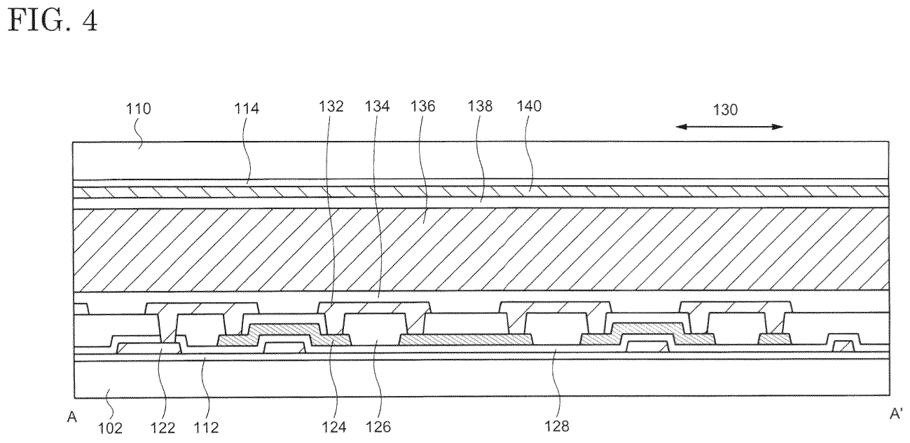

In the example shown in FIG. 3, the resistive elements 124 are provided over the substrate 102, over which the first electrodes 132 are provided through the first interlayer insulating film 126. Therefore, the wirings 122 and the first electrodes 132 may be formed as the same layer. That is, the wirings 122 and the first electrodes 132 connected thereto may be integrated and have the same composition. However, the wirings 122 and the first electrodes 132 do not necessarily exist in the same layer. For example, the wirings 122 may be provided over the substrate 102, and the resistive element 124 may be provided over the wirings 122 through a second interlayer insulating film 128 as shown in FIG. 4. In this case, the wiring 122 and the first electrode 132 are electrically connected through an opening formed in the first interlayer insulating film 126 and the second interlayer insulating film 128. The wirings 122 and the first electrodes 132 may have the same composition or may have different compositions.

### 2. Driving Method of Intelligent Reflecting Surface

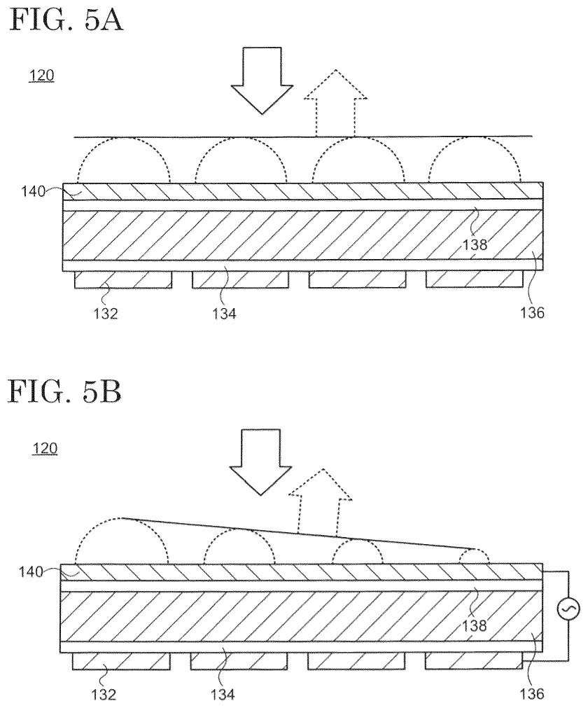

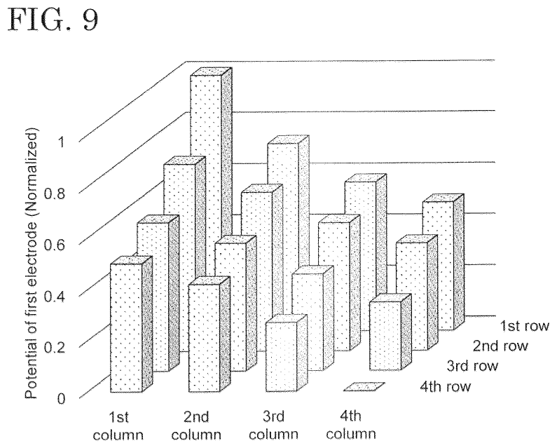

A driving method of the intelligent reflecting surface 100 is explained using FIG. 5 to FIG. 10. In the intelligent reflecting surface 100 having the aforementioned structure, the directions of the first orientation film 134 and the second orientation film 138 to orient the liquid crystal molecules are the same. Hence, when no potential difference is provided between the first electrode 132 and the second electrode 140, no vertical electric field is generated in the liquid crystal layer 136, and the liquid crystal molecules are splay-oriented. The orientation of the liquid crystal layer 136 is identical between the radio-wave reflection elements 130, and thus the permittivity is also constant within the liquid crystal layer 136. Therefore, the spread (phase shift) of the reflected waves generated when radio waves incident from the second electrode 140 side (solid white arrow in FIG. 5A) are reflected on the surface of the first electrode 132 does not change as represented by the dotted arcs in FIG. 5A. As a result, the incident radio waves are directly reflected by the intelligent reflecting surface 100, resulting in the reflected waves (dotted white arrow in FIG. 5A) with the same emission angle as the incident angle.

In contrast, when a potential difference is provided between the first electrode 132 and the second electrode 140, the liquid crystal molecules rise and are bend-oriented by the generated vertical electric field. When vertical electric fields of different intensities are generated between the radio-wave reflection elements 130, the permittivity of the liquid crystal layer 136 changes between the radio-wave reflection elements 130 according to the intensity of the vertical electric fields. As a result, the phase shift of the reflected waves changes as shown by the dotted arcs in FIG. 5B, by which the reflection direction of the incident radio waves (solid white arrow in FIG. 5B) can be changed (see dotted white arrow in FIG. 5B). The reflection direction can be controlled by changing the intensity of the vertical electric fields formed in the radio-wave reflection elements 130.

As described above, in each element group 120 of the intelligent reflecting surface 100, the first wiring 122-1 to the fourth wiring 122-4 are respectively connected to the radio-wave reflection elements 130 at the four corners, that is, the first electrodes 132 of the radio-wave reflection elements 130 in the first row and the first column, in the mth row and the first column, in the first row and the nth column, and in the mth row and the nth column. In addition, two first electrodes 132 adjacent in the row direction or the column direction are electrically connected to each other through the resistive element 124. When the intelligent reflecting surface 100 is driven by independently supplying the control potentials to the first wiring 122-1 to the fourth wiring 122-4, the potentials of the first electrodes 132 in each element group 120 can be adjusted by utilizing the resistive voltage division caused by the resistive element 124. At the same time, a constant potential is supplied to the second electrode 140. Therefore, the intensities of the vertical electric fields generated in all of the radio-wave reflection elements 130 can be controlled by adjusting the control potentials supplied to the radio-wave reflection elements 130 located at the four corners in each element group 120.

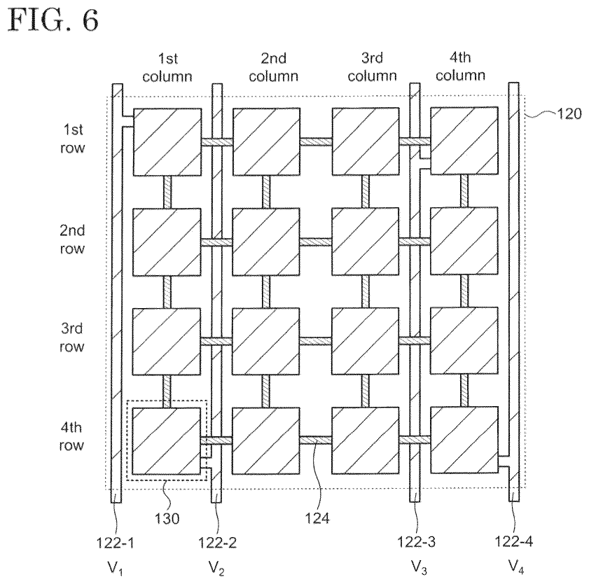

As an example, a case is considered where each element group 120 has 16 radio-wave reflection elements 130 arranged in a matrix shape with 4 rows and 4 columns (i.e., in a case where m and n are each 4) as shown in FIG. 6, the first wiring 122 to the four wiring 122-4 respectively connected to the radio-wave reflection elements 130 in the first row and the first column, in the mth row and the first column, in the first row and the nth column, and in the mth row and the nth column are respectively applied with potentials V₁, V₂, V₃, and V₄, and a constant potential V_{c} is applied to the second electrode 140 to drive the intelligent reflecting surface 100. For example, the potentials V₁, V₂, V₃, V₄, and V_{c} are set as shown in Table 1. High and Low are potentials relative to a constant reference (e.g., ground potential), and their absolute values are arbitrary. However, High is a potential with a larger absolute value than Low. High and Low are respectively 10 V and 0 V relative to a constant reference, for example. Note that although the potential V. is Low same as the potentials V3 and V4 in the example shown in Table 1, the potential V_{c} may be different from any of the potentials V₁ to V₄. The same is applied to other Tables.

TABLE 1
Potentials applied to the wirings and the second electrode.

| Wiring or electrode | Symbol | Potential |
|---|---|---|
| First wiring | V₁ | High |
| Second wiring | V₂ | High |
| Third wiring | V₃ | Low |
| Fourth wiring | V₄ | Low |
| Second electrode | V_{c} | Low |

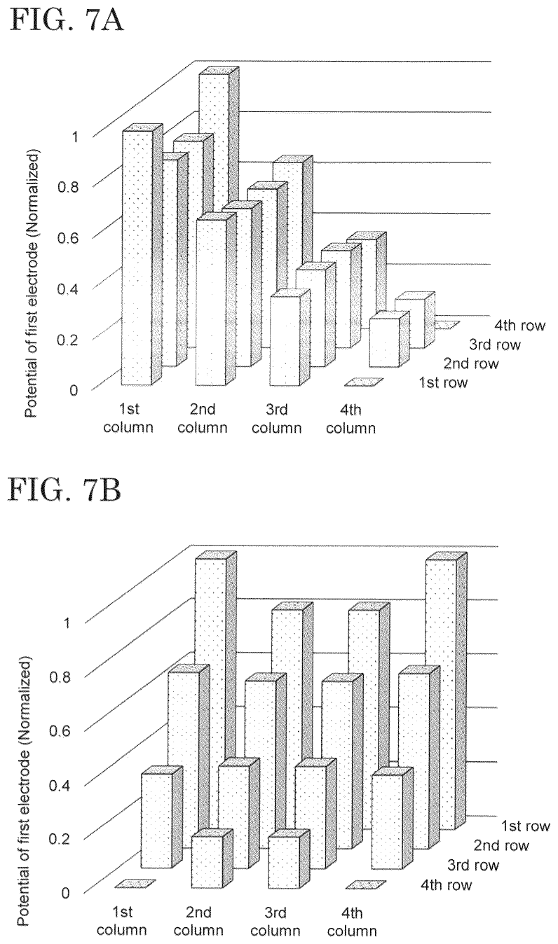

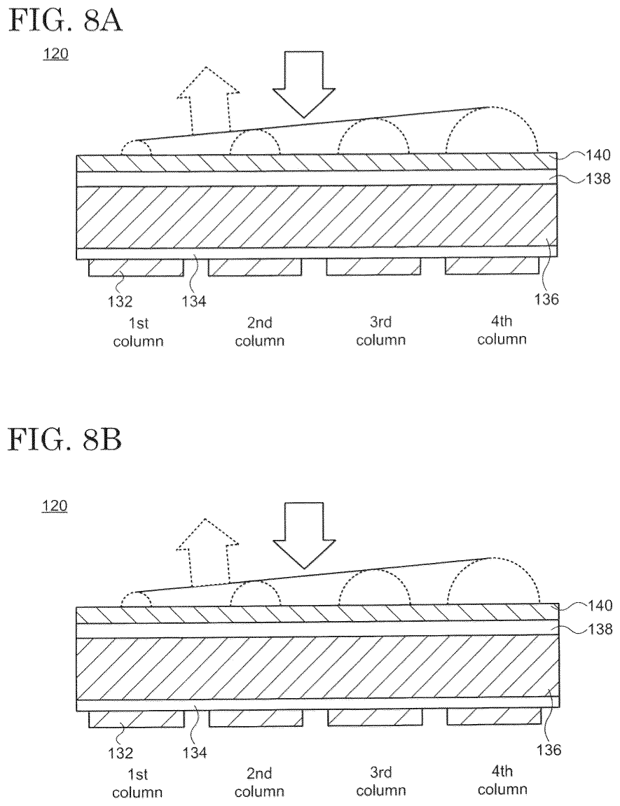

When the intelligent reflecting surface 100 is driven in this manner, although the potentials applied to the first electrodes 132 are not necessarily constant in each column due to the resistive voltage division caused by the resistive elements 124, the potentials decrease in the order of the first column, the second column, the third column, and the fourth column as shown in FIG. 7A. As a result, the phase of the reflected waves changes more significantly in the first column where the potentials of the first electrodes 132 are the highest, and the amount of the change decreases in the order of the second column, the third column, and the fourth column as shown in FIG. 8A. Therefore, the radio waves incident from the normal direction of the intelligent reflecting surface 100 (solid white arrow in FIG. 8A) are reflected in a direction rotated by a certain angle about an axis extending in the column direction (dotted white arrow). The reflection angle can be controlled by adjusting the potential applied to each wiring 122.

As a similar example, a case is considered where the intelligent reflecting surface 100 is driven by respectively applying the potentials V₁, V₂, V₃, V₄, and V_{c} shown in Table 2 to the first wiring 122-1 to the fourth wiring 122-4 and the second electrode 140.

TABLE 2
Potentials applied to the wirings and the second electrode.

| Wiring or electrode | Symbol | Potential |
|---|---|---|
| First wiring | V₁ | High |
| Second wiring | V₂ | Low |
| Third wiring | V₃ | High |
| Fourth wiring | V₄ | Low |
| Second electrode | V_{c} | Low |

In this case, the potentials applied to the first electrodes 132 are not necessarily constant in each row but decrease in the order of the first row, the second row, the third row, and the fourth row as shown in FIG. 7B. As a result, the phase of the reflected waves changes more significantly in the first row where the voltages of the first electrodes 132 are highest, and the amount of the change decreases in the order of the second row, the third row, and the fourth row as shown in FIG. 8B. Therefore, the radio waves incident from the normal direction of the intelligent reflecting surface 100 (solid white arrow in FIG. 8B) are reflected in a direction rotated by a certain angle about an axis extending in the row direction (dotted white arrow). The reflection angle can be controlled by adjusting the potential applied to each wiring 122.

As a similar example, a case is considered where the intelligent reflecting surface 100 is driven by respectively applying the potentials V₁, V₂, V₃, V₄, and V_{c} shown in Table 3 to the first wiring 122-1 to the fourth wiring 122-4 and the second electrode 140. Mid is a potential between High and Low, and High, Low, and Mid may be respectively set to be 10 V, 0 V, and 5 V relative to a constant reference.

TABLE 3
Potentials applied to the wirings and the second electrode.

| Wiring or electrode | Symbol | Potential |
|---|---|---|
| First wiring | V₁ | High |
| Second wiring | V₂ | Mid |
| Third wiring | V₃ | Mid |
| Fourth wiring | V₄ | Low |
| Second electrode | V_{c} | Low |

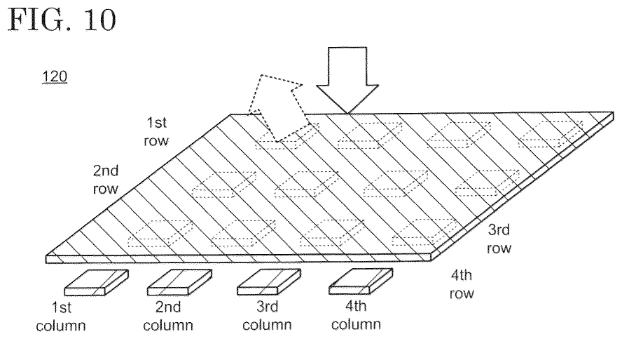

In this case, the potentials of the first electrodes 132 decrease in the order of the first row, the second row, the third row, and the fourth row in each column. In addition, the potentials of the first electrodes 132 decrease in the order of the first column, the second column, the third column, and the fourth column in each row. The amount of the phase change of the reflected waves also decreases in the order described above. Therefore, the radio waves incident from the normal direction of the intelligent reflecting surface 100 are reflected in a direction rotated about the axis extending in the column direction and the axis extending in the row direction (FIG. 10). The reflection angle can be controlled by adjusting the potential applied to each wiring 122.

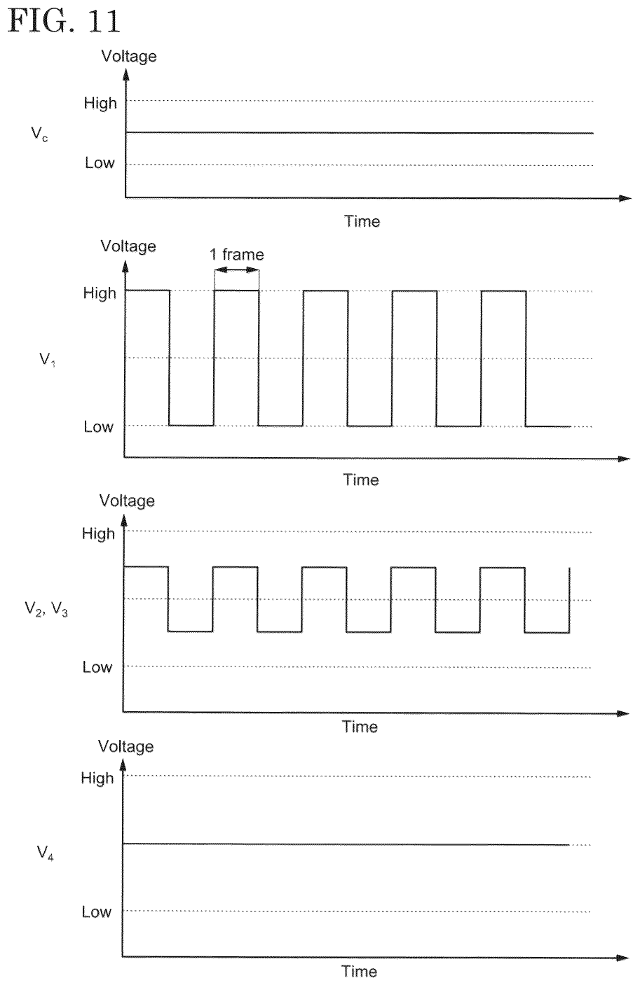

Note that a so-called inversion driving method is performed when the intelligent reflecting surface 100 is driven. That is, the intelligent reflecting surface 100 is driven so that the direction of the vertical electric field generated in the radio-wave reflection element 130 is inverted every frame. The frame period is arbitrarily determined and may be selected from a range of 1/60 second to 1 second, for example. When the case of the driving method shown in Table 3 is specifically explained using FIG. 11, the constant potential V_{c} is supplied to the second electrode 140 throughout a plurality of frames. In contrast, the polarities of the potentials V₁, V₂, and V₃ supplied to the first electrodes 132 are inverted every frame with respect to the potential V_{c} so that potentials higher and lower than the potential V_{c} alternate. Note that the wiring 122 to which a potential the same as the potential of the second electrode 140 is applied is supplied with a constant potential throughout the plurality of frames. Charge accumulation caused by a small amount of impurities included in the liquid crystal layer 136 can be prevented by employing such an inversion driving method. In addition, since a potential is always supplied to the wiring 122 in each frame in this driving method, the vertical electric field of each radio-wave reflection element 130 can be maintained without being affected by the leakage current from the liquid crystal layer 136.

As described above, in the intelligent reflecting surface 100 according to an embodiment of the present invention, the vertical electric fields of all of the radio-wave reflection elements 130 are controlled by supplying the control potentials to the radio-wave reflection elements 130 located at the four corners in each element group 120 to control the vertical electric fields thereof, by which radio waves can be reflected in an arbitral direction. In this intelligent reflecting surface 100, an element such as a transistor to control the radio-wave reflection elements 130 and a capacitor element to hold the potential of the liquid crystal layer 136 is not required, and it is not necessary to fabricate a driver circuit over the substrate 102 to generate signals to be supplied to a transistor and a storage capacitor. Furthermore, since the characteristics of the intelligent reflecting surface 100 can be controlled simply by supplying four types of control potentials, the structure of not only the intelligent reflecting surface 100 but also the external circuit for controlling the intelligent reflecting surface 100 can be simplified. Therefore, implementation of an embodiment of the present invention enables the production of an intelligent reflecting surface at a low cost.

### 3. Modified Example

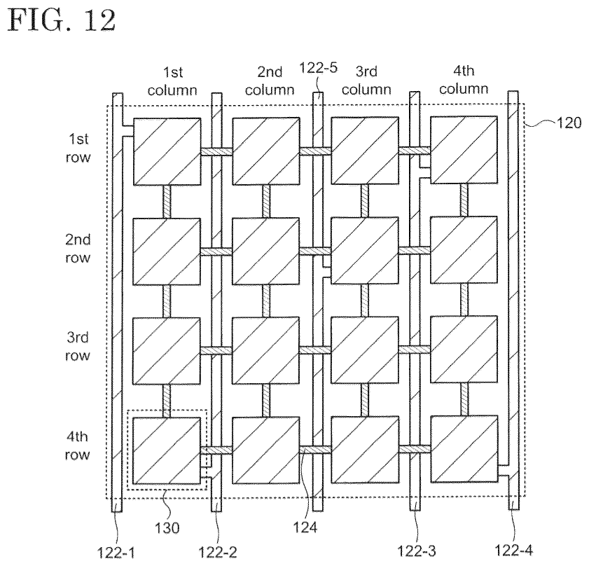

The structure of the intelligent reflecting surface 100 is not limited to the aforementioned structure. For example, the intelligent reflecting surface 100 may include a fifth wiring 122-5 in addition to the first wiring 122-1 to the fourth wiring 122-4 as shown in the schematic top view of one element group 120 (FIG. 12). The fifth wiring 122-5 is also configured to be supplied with an electric potential independently from the first wiring 122-1 to the fourth wiring 122-4. The fifth wiring 122-5 is connected to any radio-wave reflection element 130 other than the radio-wave reflection elements 130 located at the four corners of the element group 120. Preferably, the fifth wiring 122-5 is connected to the first electrode 132 of the radio-wave reflection element 130 located at or near the center of the element group 120.

More specifically, the fifth wiring 122-5 is connected to the radio-wave reflection element 130 in the jth row and the kth column. Preferably, j is m/2 or m/2+1 when m is even, and j is m/2+0.5 when m is odd. Preferably, k is n/2 or n/2+1 when n is even, and k is n/2+0.5 when n is odd.

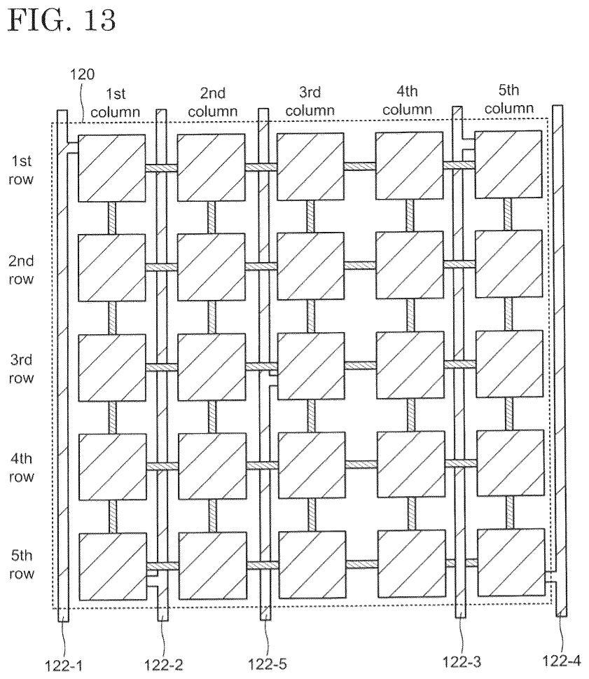

In the example shown in FIG. 12, both m and n are 4, 2 corresponding to m/2 is employed as j, and 3 corresponding to n/2+1 is employed as k. Accordingly, the fifth wiring 122-5 is connected to the radio-wave reflection element 130 in the second row and the third column. In the example shown in FIG. 13, both m and n are 5, 3 corresponding to m/2+0.5 is employed as j, and 3 corresponding to n/2+0.5 is employed as k. Accordingly, the fifth wiring 122-5 is connected to the radio-wave reflection element 130 in the third row and the third column. Although not illustrated, additional wirings may be provided in addition to the first wiring 122-1 to the fifth wiring 122-5.

Thus, the control potentials are additionally supplied to one or multiple radio-wave reflection elements 130 in addition to those located at the four corners of each element group 120, by which the characteristics of the radio-wave reflection elements 130 in each element group 120 can be more precisely controlled.

The aforementioned modes described as the embodiments of the present invention can be implemented by appropriately combining with each other as long as no contradiction is caused. Furthermore, any mode which is realized by persons ordinarily skilled in the art through the appropriate addition, deletion, or design change of elements or through the addition, deletion, or condition change of a process on the basis of the radio-wave reflection element or the intelligent reflecting surface is included in the scope of the present invention as long as they possess the concept of the present invention.

It is understood that another effect different from that provided by each of the aforementioned embodiments is achieved by the present invention if the effect is obvious from the description in the specification or readily conceived by persons ordinarily skilled in the art.

What is claimed is:

1. An intelligent reflecting surface comprising:
at least one element group comprising a plurality of radio-wave reflection elements arranged in a matrix shape having a first row to a mth row and a first column to a nth column (m and n are independently a natural number equal to or greater than 2), each of the plurality of radio-wave reflection elements comprising a first electrode, a liquid crystal layer over the first electrode, and a second electrode over the liquid crystal layer,
wherein, in the at least one element group, the first electrode is electrically connected to an adjacent first electrode in a row direction and a column direction through a resistive element,
a resistance of the resistive element is higher than a resistance of the first electrode, and
m and n are independently selected from natural numbers equal to or greater than 2.

2. The intelligent reflecting surface according to claim 1,
wherein the first electrodes of the radio-wave reflection element in the first row and the first column, the radio-wave reflection element in the mth row and the first column, the radio-wave reflection element in the first row and the nth column, and the radio-wave reflection element in the mth row and the nth column are electrically connected to a first wiring, a second wiring, a third wiring, and a fourth wiring, respectively, and
the first wiring, the second wiring, the third wiring, and the fourth wiring are configured to be independently supplied with a potential.

3. The intelligent reflecting surface according to claim 1,
wherein the second electrodes are integrated and shared by the plurality of radio-wave reflection elements.

4. The intelligent reflecting surface according to claim 2,
wherein the second electrodes are configured to be supplied with a constant potential, and
a polarity of each of the potentials supplied to the first wiring, the second wiring, the third wiring, and the fourth wiring is inverted every frame with respect to the potential supplied to the second electrodes.

5. The intelligent reflecting surface according to claim 1,
wherein the resistive element includes a light-transmitting conductive oxide or dopant-containing silicon.

6. The intelligent reflecting surface according to claim 2,
wherein n and m are independently equal to or greater than 4,
the first electrode of the radio-wave reflection element in a jth row and a kth column is connected to a fifth wiring supplied with a potential independently from the first wiring, the second wiring, the third wiring, and the fourth wiring,
the jth row and the kth column are respectively selected from the first row to the mth row and the first column to the nth column,
j is a natural number greater than 1 and smaller than m, and
k is a natural number greater than 1 and smaller than n.

7. The intelligent reflecting surface according to claim 6,
wherein j is m/2 or m/2+1 when m is even,
j is m/2+0.5 when m is odd,
k is n/2 or n/2+1 when n is even, and
k is n/2+0.5 when n is odd.

8. The intelligent reflecting surface according to claim 1,
wherein the first electrodes of the adjacent radio-wave reflection elements are directly connected to the resistive element electrically connecting the adjacent radio-wave reflection elements.

9. The intelligent reflecting surface according to claim 1,
wherein the at least one element group includes a plurality of element groups.

10. A driving method of an intelligent reflecting surface comprising at least one element group including a plurality of radio-wave reflection elements arranged in a matrix shape having a first row to a mth row and a first column to a nth column, each of the plurality of radio-wave reflection elements comprising a first electrode, a liquid crystal layer over the first electrode, and a second electrode over the liquid crystal layer, the driving method comprising independently supplying a potential to the first electrodes of the radio-wave reflection element in the first row and the first column, the radio-wave reflection element in the mth row and the first column, the radio-wave reflection element in the first row and the nth column, and the radio-wave reflection element in the mth row and the nth column,
wherein, in the at least one element group, the first electrode is electrically connected to an adjacent first electrode in a row direction and a column direction through a resistive element, and
m and n are independently selected from natural numbers equal to or greater than 2.

11. The driving method according to claim 10,
wherein the second electrodes are integrated and shared by the plurality of radio-wave reflection elements.

12. The driving method according to claim 10, further comprising:
supplying the second electrode with a constant potential; and
inverting a polarity of each of the potentials supplied to the first electrodes of the radio-wave reflection element in the first row and the first column, the radio-wave reflection element in the mth row and the first column, the radio-wave reflection element in the first row and the nth column, and the radio-wave reflection element in the mth row and the nth column every frame with respect to the potential supplied to the second electrodes.

13. The driving method according to claim 10,
wherein the resistive element includes a light-transmitting conductive oxide or dopant-containing silicon.

14. The driving method according to claim 10, further comprising supplying the first electrode of the radio-wave reflection element in a jth row and a kth column with a potential independent from the potentials supplied to the first electrodes of the radio-wave reflection element in the first row and the first column, the radio-wave reflection element in the mth row and the first column, the radio-wave reflection element in the first row and the nth column, and the radio-wave reflection element in the mth row and the nth column,
wherein the jth row and the kth column are respectively selected from the first row to the mth row and the first column to the nth column,
n and m are independently selected from natural numbers equal to or greater than 4,
j is a natural number greater than 1 and smaller than m, and
k is a natural number greater than 1 and smaller than n.

15. The driving method according to claim 14,
wherein j is m/2 or m/2+1 when m is even,
j is m/2+0.5 when m is odd,
k is n/2 or n/2+1 when n is even, and
k is n/2+0.5 when n is odd.

16. The driving method according to claim 10,
wherein the first electrodes of the adjacent radio-wave reflection elements are directly connected to the resistive element electrically connecting the adjacent radio-wave reflection elements.

17. The driving method according to claim 10,
wherein the at least one element group includes a plurality of element groups.
